(19) United States
(12) Patent Application Publication
(10) Pub. No.: US 2012/0072365 A1
(43) Pub. Date: Mar. 22, 2012

(54) AIR WAYBILL FISCAL CONTROL AND AUTHORIZATION

(76) Inventors: William A. Loebertmann, Shakopee, MN (US); JoAnne Jancik, Victoria, MN (US); Newton Rocha, Rio De Janeiro (BR)

(21) Appl. No.: 12/886,946

(22) Filed: Sep. 21, 2010

(51) Int. Cl. G06Q 10/00

(52) U.S. Cl. 705/342

(57) ABSTRACT

Air waybills may be used by governments to aid in tax collection efforts. Conventionally, air waybills are printed on forms with pre-printed air waybill numbers and the number from the form entered into electronic storage. The air waybills may be used by some governments to assess taxes. New government rules allow the submission of electronic air waybills to government servers for tax enforcement. Electronic air waybills may be implemented by a computer system to increase the efficiency and productivity when accounting for shipments through a county. For example, air waybill numbers and fiscal identifier numbers may be assigned to an air waybill electronically. The air waybill is then transmitted to the government server for approval. Upon acceptance by the government of the air waybill the computer system may print the issued waybill.

### TECHNICAL FIELD

The present invention relates to a computer system. More specifically, the present invention relates to a tracking system for air waybills.

### BACKGROUND OF THE INVENTION

Air waybills (AWBs) are legal documents describing a contract between an air line and a shipper (or IATA agent). Conventionally, the air waybill forms are printed on forms with pre-printed air waybill numbers. In order to electronically track shipments, shippers enter the air waybill number from the pre-printed form into a computer system. Thus, each time an air waybill form is issued (printed), a user manually enters the air waybill number pre-printed on the air waybill form into a computer system. Manually entering the air waybill numbers is a time consuming process, which reduces the efficiency and productivity of the carrier's staff.

### BRIEF SUMMARY OF THE INVENTION

According to one embodiment, a method includes receiving information to create an air waybill (AWB). The method also includes assigning an AWB number and a fiscal number to the AWB. The method further includes sending the AWB to an authorization server. The method also includes receiving an authorization response from the authorization server before issuing the AWB.

According to another embodiment, a computer program product includes a computer-readable medium having code to receive information to create an air waybill (AWB). The medium also includes code to assign an AWB number and a fiscal number to the AWB. The medium further includes code to send the AWB to an authorization server. The medium also includes code to receive an authorization response from the authorization server before issuing the AWB.

According to a further embodiment, an apparatus includes a processor and a memory coupled to the processor. The processor is configured to receive information to create an air waybill (AWB). The processor is further configured to assign an AWB number and a fiscal number to the AWB. The processor is also configured to send the AWB to an authorization server. The processor is further configured to receive an authorization response from the authorization server before issuing the AWB.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the technology of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present invention, reference is now made to the following descriptions taken in conjunction with the accompanying drawings.

FIG. 1 illustrates one embodiment of a system for generating and/or storing air waybills.

FIG. 2 illustrates one embodiment of a data management system configured to process air waybills.

FIG. 3 is a schematic block diagram illustrating one embodiment of an exemplary computer system that may be used in accordance with certain embodiments of the system for processing air waybills.

FIG. 4 is a flow chart illustrating a method for issuing an air waybill according to one embodiment.

FIG. 5 is a form illustrating assigning fiscal numbers according to one embodiment.

FIG. 6 is a form illustrating editing air waybills according to one embodiment.

### DETAILED DESCRIPTION OF THE INVENTION

Improvements in efficiency and productivity when tracking air waybills may be accomplished by electronically generating air waybill numbers for air waybills and fiscal numbers for the air waybills. The electronically-generated air waybill number and fiscal number for an air waybill may be transmitted to an authorization server, which authorizes and records the air waybill number and the fiscal number. Upon receipt of an approval from the authorization server an air waybill may be issued (printed) and may be stored in an electronic application. According to one embodiment, the authorization server may be a government server for tracking air waybills for tax collection. For example, Brazil has recently established an electronic system for recording and approving air waybills.

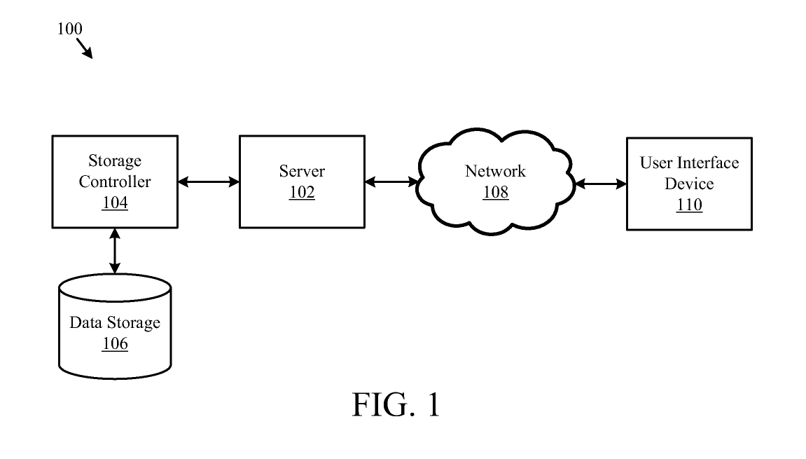

FIG. 1 illustrates one embodiment of a system 100 for generating and/or storing air waybills. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter information for an air waybill into the system 100.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to store air waybills and request authorization for air waybills from a government authorization server. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store air waybills. The data may be arranged in a database and accessible through Structured Query Language (SQL) queries, or other data base query languages or operations.

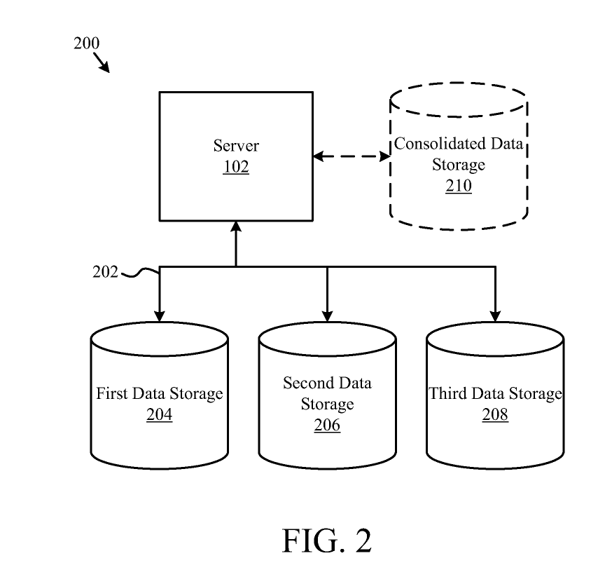

FIG. 2 illustrates one embodiment of a data management system 200 configured to process air waybills. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

In one embodiment, the server 102 may submit a query to selected data storage devices 204, 206 to collect stored air waybill numbers. The server 102 may store the consolidated data set in a consolidated data storage device 210. In such an embodiment, the server 102 may refer back to the consolidated data storage device 210 to obtain a set of data elements associated with a specified air waybill. Alternatively, the server 102 may query each of the data storage devices 204, 206, 208 independently or in a distributed query to obtain the set of data elements associated with an air waybill. In another alternative embodiment, multiple databases may be stored on a single consolidated data storage device 210.

The data management system 200 may also include files for administering and generating air waybills. In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may host a software application configured for generating, storing, and/or obtaining authorization for an air waybill. The software application may further include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

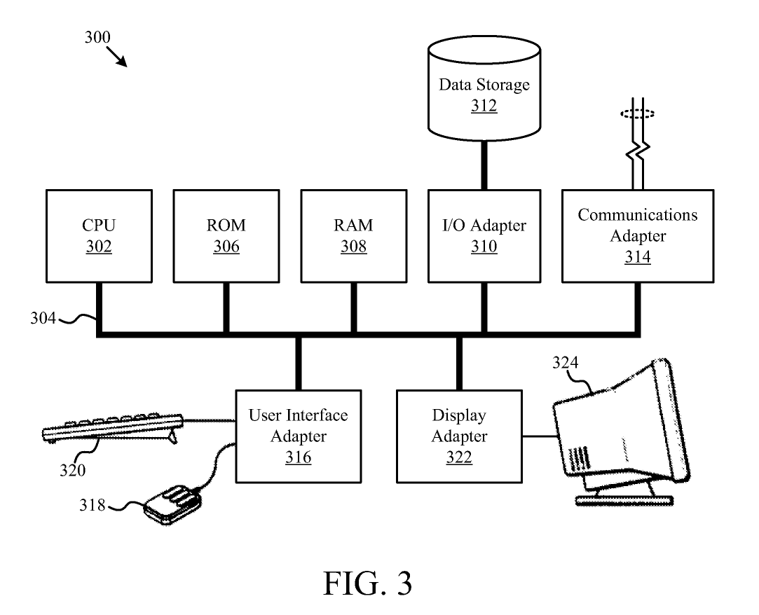

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application having code to electronically generate air waybills. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input information for an air waybill. In a further embodiment, the display adapter 322 may display a graphical user interface associated with a software or web-based application for generating, storing, and/or authorizing air waybills.

The I/O adapter 310 may connect one or more storage devices 312, such as one or more of a hard drive, a compact disk (CD) drive, a floppy disk drive, a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

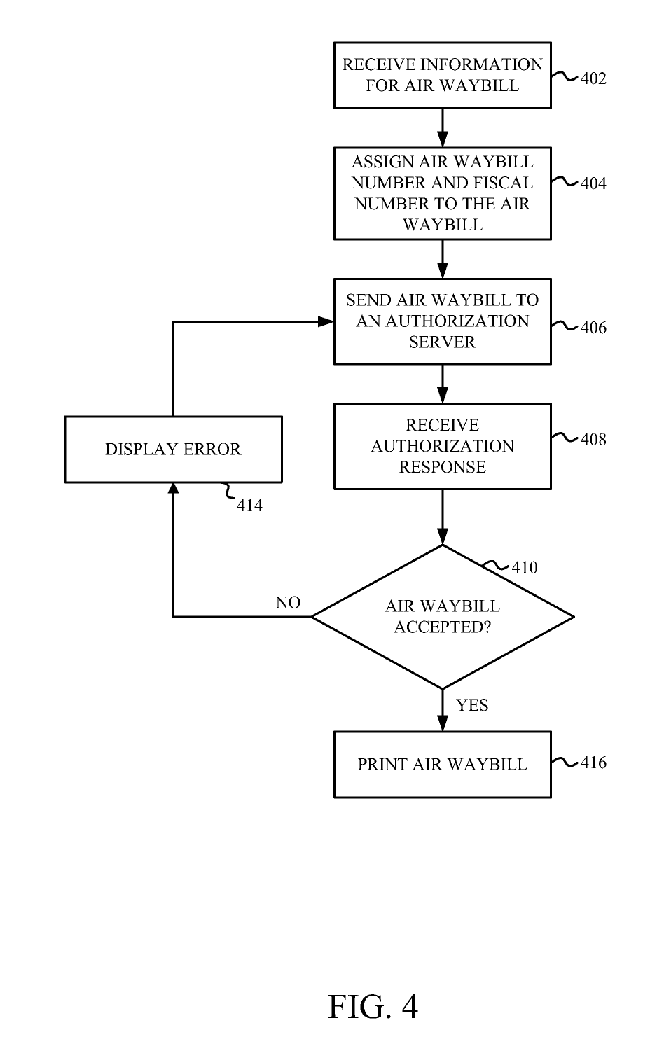

FIG. 4 is a flow chart illustrating a method for issuing an air waybill according to one embodiment. At block 402 information is received for completing an air waybill. The information may include, for example, shipper, contents of the shipment, destination of the shipment, and origin of the shipment. At block 404 an air waybill number and a fiscal identifier are assigned to the air waybill. The air waybill number may be selected from a stock of air waybill numbers available to the user. At block 406 the air waybill is transmitted to an authorization server. The air waybill may be transmitted as an extensible markup language (XML) file. The authorization server may be, for example, a government server for approving air waybills. According to one embodiment, the air waybill may be generated and sent through one or more internal authorization servers before transmission to an external authorization server such as the government authorization server. At block 408 an authorization response is received from the authorization server. At block 410 the response is determined to be an accepted air waybill or a rejected air waybill. If the air waybill is accepted, the method proceeds to block 416 to print the air waybill. If the air waybill is not accepted, the method proceeds to block 414 to display an error. According to one embodiment, additional information may be received for the air waybill and the method continues to block 406 to re-transmit the air waybill to the authorization server with the additional information.

The fiscal number assigned to an air waybill may be 12 characters in length having three digits indicating a series number and nine digits indicating a counter identification (ID). Thus, the fiscal number may range from 000000000001 to 99999999999. The fiscal range may be unique to a geographical area such that identical fiscal numbers may be used in different geographical areas to represent different air waybills. For example, fiscal numbers in Sao Paulo state of Brazil may be are unique to fiscal numbers in the Rio de Janeiro state of Brazil.

When air waybill numbers are assigned electronically a computer system may be used to assign and track air waybill numbers. For example, the air waybill numbers may be tracked as inventory at an assigned location. Thus, when a user generates a new air waybill, an air waybill number may be assigned to the air waybill based on a previous assignment of air waybill numbers to the user's location or the shipment's location. Air waybill number assignments may be displayed, entered, and/or updated through a form.

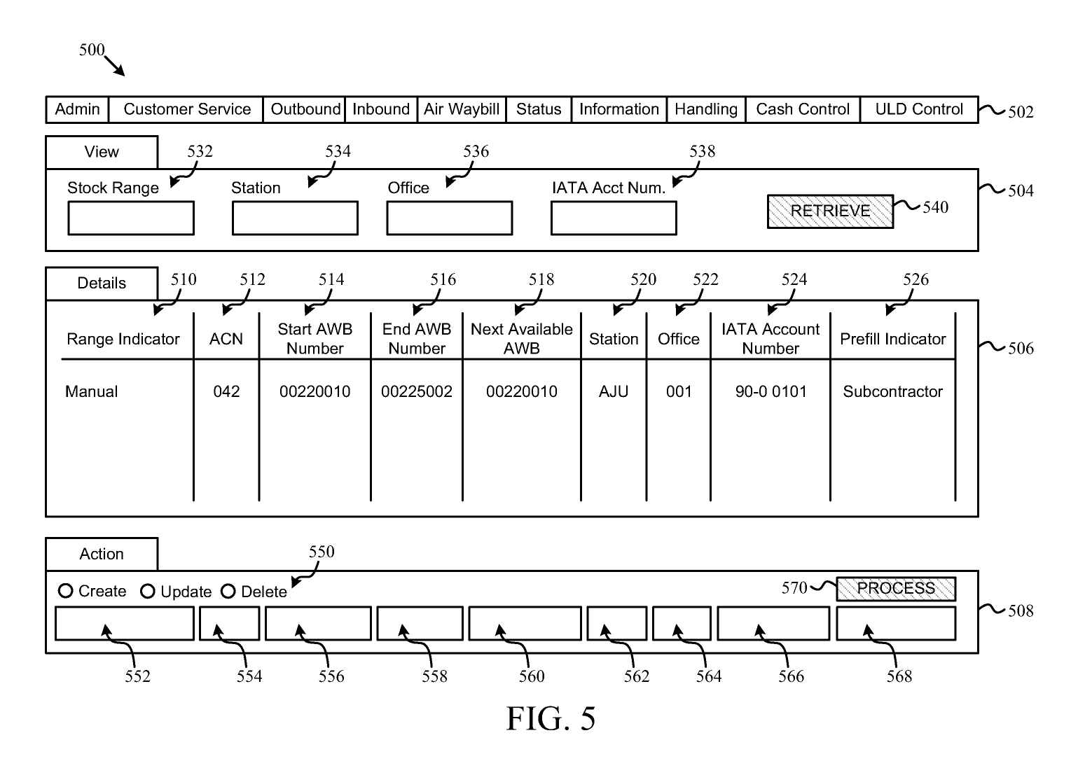

FIG. 5 is a form illustrating assigning air waybill numbers according to one embodiment. A form 500 may obtain input from a user for assigning air waybill numbers. The form 500 includes a menu control 502, and sections 504, 506, 508. The section 504 allows retrieval of air waybill number assignments based on at least one of stock range, station, office, and IATA account number. A user may enter information into one or more of the input boxes 532, 534, 536, 538 of the section 504 and press the retrieve button 540 to retrieve assigned air waybill numbers meeting the entered criteria. Alternatively, a user may view all of the assigned air waybill number information by leaving the boxes 532, 534, 536, 538 blank when pressing the button 540.

Assigned air waybill information is displayed in the section 506. The section 506 may include a table having columns displaying information about the assigned air waybills. According to one embodiment, the table includes a range indicator column 510, an airline code number (ACN) column 512, a start air waybill (AWB) number column 514, an end AWB number column 516, a next available AWB column 518, a station column 520, an office column 522, an IATA account number column 524, and a pre-fill indicator column 526. Each line in the table of section 506 provides information for an air waybill stock range. The start AWB number column 514 indicates the starting AWB number in the air waybill stock range, and the end AWB number column 516 indicates the ending AWB number of the air waybill stock range. The next available AWB number column 518 indicates the next air waybill number that is available for use in the air waybill stock range. For example, if a new AWB is generated and printed from the air waybill stock range, the next available AWB displayed in the column 518 may be assigned to the AWB.

The range indicator column 510 may indicate if the air waybill stock range is an air waybill range reserved for system use, domestic system use, manual use, or if the air waybill stock range is blacklisted. The pre-fill indicator column 526 may indicate whether a default participant is pre-filled for AWBs generated in the AWB stock range. For example, no participant may be prefilled, an agent participant may be prefilled, a shipper participant may be prefilled, both the shipper and participant information may be prefilled, or the subcontractor may be prefilled for the displayed AWB stock range. The IATA account number column 524 displays the IATA cargo agent code. According to one embodiment, an IATA account number may indicate the IATA account number associated with a station displayed in the station column 520.

According to one embodiment, warning levels may be configured to trigger a warning message to a user or a system administrator. For example, when the number of AWB numbers remaining in an AWB stock range reaches a threshold number, a warning message may be displayed with the form 500 or placed in a system queue for delivery to a system administrator.

The section 508 allows input for creation, updating, or deleting an AWB stock range depending on the selection of radio buttons 550. The user may enter information corresponding to range indicator, ACN, start AWB number, end AWB number, next available AWB number, station, office, IATA account number, and pre-fill indicator in boxes 552, 554, 556, 558, 560, 562, 564, 566, 568, respectively. After entering data and selecting a radio button 550 the user presses a process button 570 to perform the action selected by the radio button 550. The new or updated information may be displayed in the section 506.

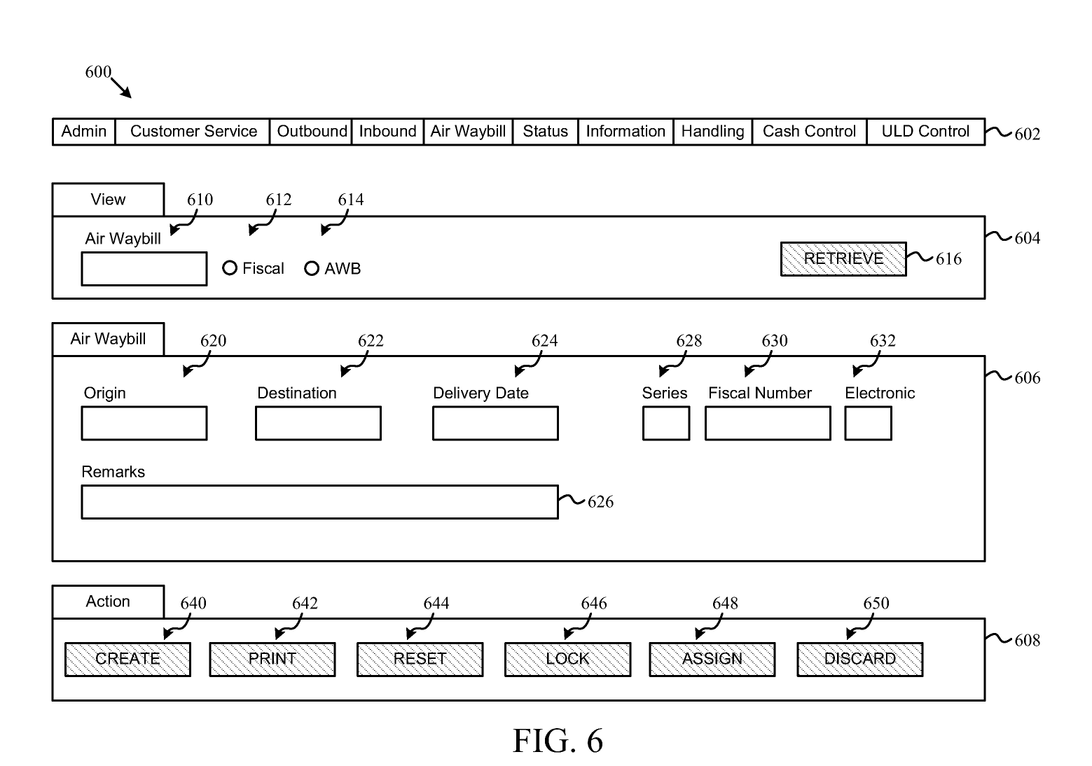

Air waybills may be created, updated, deleted, and/or printed through a form on a computer system. According to one embodiment, the air waybill form may be reached by clicking on Air Waybill in the menu control 502. FIG. 6 is a form illustrating editing air waybills according to one embodiment. A form 600 may include a menu control 602 and sections 604, 606, 608. The section 604 may allow a user to retrieve a specific air waybill by entering an identifying number in an input box 610 and selecting a identifier type in radio buttons 612, 614. An air waybill number may include an airline code number (ACN) and a shipment reference number. According to one embodiment, a user may search for air waybills by the fiscal identifier or the air waybill number. When a user presses a retrieve button 616, information corresponding to the entered identifier in the input box 610 is displayed in section 606.

The section 606 may display information such as origin, destination, delivery date, remarks, fiscal series, fiscal number, and electronic submission in boxes 620, 622, 624, 626, 628, 630, and 632, respectively. The fiscal series, fiscal number, and electronic submission boxes 628, 630, 632 may be display-only fields and not accept user input. The electronic submission box 632 indicates whether the displayed air waybill was generated electronically through an authorization server. According to one embodiment, a user may enter changes to the information for the retrieved air waybill in the section 606. According to another embodiment, the user may enter information for a new waybill into the section 606. After entering and/or editing data in the section 606, the user may select from actions available for the air waybill in the section 608. For example, a user may select from a create button 640, a print button 642, a reset button 644, a lock button 646, an assign button 648, and a discard button 650.

If the lock button 646 is pressed the air waybill is locked and all future changes may be recorded in an air waybill history. If the assign button 648 is pressed the air waybill number is assigned to a reference booking, and a pop-up window may be displayed to allow entry of an air waybill number. If the lock button 646 is pressed the information for the air waybill may be locked from future changes by users. If the print button 642 is pressed the air waybill may be printed. If the create button 640 is pressed the information entered in boxes 620, 62, 624, 626 may be added to an air waybill. Then the air waybill may be processed as described above in FIG. 4 to authorize the air waybill with an authorization server. When the fiscal identifier is assigned the boxes 628, 630, 632 may change to indicate the assigned fiscal identifier. According to one embodiment, the air waybill may include additional information such as manifest information and invoice information.

If the discard button 650 is pressed the air waybill may be deleted. According to one embodiment, the discard button 650 is available only if the air waybill has not been authorized by an authorization server. If the air waybill was previously authorized additional processes may be performed to inform the authorization server of the deletion. For example, a simple object access protocol (SOAP) request may be submitted to the government server with the air waybill number and instruction to delete the air waybill. Next, a second SOAP request may be sent to the government server requesting the status of the deletion request. If no status update is available from the government server, additional SOAP requests may be submitted until the deletion request status has been received. A pop-up window in the form 600 may be displayed to the user with the status of the deletion request.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving information to create an air waybill (AWB);
assigning an AWB number and a fiscal number to the AWB;
sending the AWB to an authorization server; and
receiving an authorization response from the authorization server before issuing the AWB.

2. The method of claim 1, in which sending the AWB comprises sending an XML file.

3. The method of claim 2, in which sending the XML file to the authorization server comprises sending the XML file to the government authorization server.

4. The method of claim 1, further comprising issuing the AWB when a positive authorization response is received from the authorization server.

5. The method of claim 1, further comprising displaying a request for additional information when a negative authorization response is received from the authorization server.

6. The method of claim 1, in which assigning the fiscal number to the AWB comprises assigning a series number and a counter identification.

7. The method of claim 1, in which assigning the fiscal number comprises assigning the fiscal number based, in part, on at least one of an airport, a territory, and a sequential number.

8. A computer program product, comprising:
a computer-readable medium comprising:
code to receive information to create an air waybill (AWB);
code to assign an AWB number and a fiscal number to the AWB;
code to send the AWB to an authorization server; and
code to receive an authorization response from the authorization server before issuing the AWB.

9. The computer program product of claim 8, in which the code to send the AWB sends the AWB as an XML file.

10. The computer program product of claim 9, in which the code to send the XML file sends the XML file to the government authorization server.

11. The computer program product of claim 8, in which the medium further comprises code to issue the AWB if a positive authorization response is received from the authorization server.

12. The computer program product of claim 8, in which the medium further comprises code to display a request for additional information when a negative authorization response is received from the authorization server.

13. The computer program product of claim 8, in which the code to assign the fiscal number to the AWB assigns a series number and a counter identification to the AWB.

14. The computer program product of claim 8, in which the code to assign the fiscal number assigns the fiscal number based, in part, on at least one of an airport, a territory, and a sequential number.

15. An apparatus, comprising:
at least one processor; and
a memory coupled to the at least one processor,
in which the at least one processor is configured:
to receive information to create an air waybill (AWB);
to assign an AWB number and a fiscal number to the AWB;
to send the AWB to an authorization server; and
to receive an authorization response from the authorization server before issuing the AWB.

16. The apparatus of claim 15, in which the processor is configured to send the AWB as an XML file.

17. The apparatus of claim 16, in which the processor is configured to send the XML file to the government authorization server.

18. The apparatus of claim 15, in which the processor is further configured to issue the AWB if a positive authorization response is received from the authorization server.

19. The apparatus of claim 15, in which the processor is further configured to display a request for additional information when a negative authorization response is received from the authorization server

20. The apparatus of claim 15, in which the processor is configured to assign a series number and a counter identification as the fiscal number to the AWB.
